(19) United States
(12) Patent Application Publication
(10) Pub. No.: US 2004/0090458 A1
(43) Pub. Date: May 13, 2004

(54) Method and apparatus for previewing GUI design and providing screen-to-source association

(76) Inventors: John Chung Wah Yu, Singapore (SG); Kin Onn Low, Singapore (SG)

Correspondence Address: SCIOWORKS TECHNOLOGIES PTE LT D., 8 DOVER RISE, # 02-03 HERITAGE VIEW, SINGAPORE, 38679, SG

(21) Appl. No.: 10/291,588

(22) Filed: Nov. 12, 2002

(51) Int. Cl. G09G 5/00

(52) U.S. Cl. 345/760; 345/853

(57) ABSTRACT

A method and apparatus for previewing resulting screens of UI scripts of client-server information systems and providing screen-to-source association of those UI scripts. The process includes translating UI scripts into UI instructions to be displayed in the clients without executing the scripts in a server or modifying the clients, prompting a user to provide inputs for configuration items so that UI components with conditional logic can be properly previewed and inserting extra logic and data into the generated UI instructions so that when a user selects a location on a screen the corresponding section of a UI scripts will be displayed and highlighted.

### CROSS-REFERENCE TO RELATED APPLICATIONS

Not applicable.

### FEDERALLY SPONSORED RESEARCH AND DEVELOPMENT

Not applicable.

### BACKGROUND

1. Field of Invention

This invention is related to the field of development of graphical user interface of information systems. Specifically, this invention is related to a method and an apparatus for previewing resulting screens of UI scripts of client-server information systems and providing screen-to-source association for those UI scripts.

2. Description of Prior Art

A client-server information system (application) is a computational architecture that involves client processes (clients) requesting service from server processes (servers). In such architecture, the clients and the servers run on different computing devices communicate via a computer network. While the clients manage the user interface (UI) portion of the application, interact with the users and send requests to the servers to perform application-specific tasks, the servers manage shared resources and respond to client requests by executing application-specific logic, performing database operations and returning UI instructions back to the clients directing them to update their screens accordingly. Typically, there will be one server and multiple clients.

One way to implement a client-server information system is to utilize World Wide Web (Web) technologies operating on the global Internet or private Intranets. In such implementations, the network transportation protocol will be Transportation Communication Protocol/Internet Protocol (TCP/IP) and the client-server protocol will be Hypertext Transfer Protocol (HTTP). The clients will be graphical HTTP user agents commonly known as browsers and the servers will be a type of HTTP servers commonly known as application servers. The UI instructions delivered on HTTP will be a combination of Hypertext Markup Language (HTML) and Javascript and the screens are rendered (i.e. displayed) by the browsers as graphical user interface (GUI) screens. Such client-server information systems are usually called web applications.

In a web application, to provide useful application-specific services to the users, the server needs to dynamically construct the GUI screens, and hence the HTML responses, based on the requests and the current state of the application. While there are many ways to program the server to construct the HTML responses dynamically, currently the preferred approach is to use one of the many types of “UI scripting” languages. Examples of existing UI scripting languages are Sun Microsystems' JavaServer Pages (JSP), Microsoft's Active Server Pages, and Macromedia® ColdFusion® software. UI scripts contain code, usually called custom tags or UI components, representing reusable components that will be executed by the server to generate HTML fragments. Besides, the scripts allow mixing custom tags with static HTML tags. Thus, UI scripts allow a GUI screen to be composed from dynamic UI components embedded inside static HTML templates.

UI scripting is preferred over other older technologies, like Common Gateway Interface (CGI) programs, because UI scripts are relatively more maintainable and readable. This reduces the maintenance cost, and hence the total cost of ownership, of the web applications. However, UI scripting shares a drawback common in the older technologies, namely the lack of an effective and efficient mean to allow application programmers to visualize the screen designs when developing the applications. Since UI scripts are not plain HTML files, normal browsers will not be able to display them correctly. This deficiency of screen visualization hinders the efficiency of the programmers in two folds: first, without the ability to preview the design of the screens the programmers do not have any feedback of the correctness of their design until the applications are executed; second, without the ability to associate screen locations to the corresponding code fragments in the scripts the programmers cannot easily locate the underlying source when they need to modify portions of the screens. These two issues will be referred as the problem of “previewing” and the problem of “screen-to-source association”. Currently, there are a few existing methods and practices to overcome this problem. However, all of them entail one or more shortcomings. These existing methods and practices and their shortcomings are described below.

Without any help from specific tools, the most primitive approach is to actually deploy and execute the web applications. In this practice, an application programmer will first code the UI scripts and then follow the deployment procedures to deploy and execute the application in an actual server each time they need to verify the design of their screens. Such procedures are usually complex and time-consuming, involving re-compiling part of or entire application and shutting down and re-starting the server. They also involve copying, packaging and placing the script files and other dependent files at certain fixed locations. These are required because “development-time” directory structure is usually very different from the “deployment-time” directory structure. Development-time directory structure is usually tailored to facilitate source control management (SCM) according to team structure while deployment directory structure is tailored according to the requirement of the underlying software platform.

The execution of these deployment procedures makes the development and debugging cycle unnecessarily long and tedious. In addition, the execution of the scripts requires the readiness of business logic, data schema and data on which the scripts are depending. This makes it very difficult to decouple the development of the UI portion of the application from the development of the rest of the application. Lastly, this approach does not address the problem of screen-to-source association.

A variation of this approach is to utilize an Integrated Development Environment (IDE), which contains an embedded server or is capable of collaborating with an external server by acting as a client. Such IDE usually provides tools to streamline the deployment procedures and an editor capable of displaying the resulting screens upon executing the application and locating and displaying the section of source when a programmer select a screen location with a pointing device. Macromedia® DreamWeaver® UItraDev™ software is an example of such IDE. This approach addresses the problem of screen-to-source association and simplifies the deployment procedure. However, it still inherits all the shortcomings of executing the applications, namely the time-consuming deployment cycle and the dependency of the rest of the application.

A programmer cannot easily view the UI scripts because the scripts are not plain HTML files and cannot be displayed by normal browsers correctly. Recognizing this, another approach is to break the UI development into two phases: in phase one, a graphical designer designs the graphical layout of the UI screens in pure HTML using a what-you-see-is-what-you-get (WYSIWYG) HTML editor; in phase two, a programmer uses these resulting HTML files as starting points and turns them into UI script by inserting UI components to replace “mockup up placeholders”. The programmer sometimes will fulfill also the role of the designer himself. In this approach, the programmer can view the design of the screens in the first phase. However, once UI scripts have been inserted, the programmer can no longer visualize the screens. That means the programmer can only view and verify if the scripts have been inserted correctly by executing the application as the previous approaches. Another problem is that an application usually goes through many iterations and maintenance cycles and the screens usually require subsequent modifications. In these subsequent modifications, the “script-nized” files cannot be converted back to pure HTML for viewing and modifying in the HTML editor.

Yet another approach is to use an IDE which is capable of displaying the scripting components as static icons or “placeholders” on the editor among the HTML template without executing the script in a server. When a programmer select a placeholder on a screen using a pointing device, the IDE will locate and display the portion of underlying source code. An example of such IDEs is Macromedia® DreamWeaver® UItraDev™ software. One problem of this approach is that the placeholders do not have the same shape and size of the actual resulting HTML elements. Therefore, the layouts of the screens shown in the IDE are usually “distorted”. A more serious problem is that the IDE will display inaccurate screens if the scripts contain UI components with conditional logic. In these cases, the IDE will not be able to determine their values at design time. For example, a UI component can turn off or on its nesting body based on a Boolean condition as shown in the following segment JSP:

<!-- Block 1-->
<logic:equals name=“displayOption” value=“table”>

<td>

<table>

...

</table>

</td>

</logic:equals>
<!-- Block 2 -->
<logic:equals name=“displayOption” value=“list”>

<td>

<ul>

...

</ul>

</td>

</logic:equals>

<logic: equals> is a custom tag (i.e. UI component) from the Struts framework, an Apache's open source project. It will show its nested body if the variable specified in the “name” attribute is evaluated to be the string literal specified in the “value” attribute. Otherwise, it will “turn off” the nested body. In the above code fragment, Block 1 and Block 2 are mutually exclusive such that only one of them will be displayed depending on the value of the variable “displayOption”. Since an IDE cannot determine at design-time what value “displayOption” will have, it will simply show both blocks and this will upset the layout of the entire screen.

### SUMMARY OF INVENTION

Each of the existing methods and approaches for visualizing the design of GUI screens of web applications has its problems. To overcome these drawbacks of the current methods, the present invention, in an embodiment, provides a computer-implemented method and apparatus for previewing resulting screens of UI scripts in normal clients (i.e. browsers) without executing the scripts in a server and providing screen-to-source association for those UI scripts. An aspect of the present invention, in an embodiment, is a translation process which translates a UI script into UI instructions based on a predetermined set of rules for rendering a screen in a client without executing the scripts in a server or requiring any modifications to be made to the client. In this translation process, the UI script is first parsed into an in-memory syntax tree. Then, the tree is scanned and searched for nodes which require configuration to help the process to determine how to generate the UI instructions for UI components such as the above-mentioned <logic: equals> custom tags. These data are collected and displayed in a GUI dialog prompting a user (i.e a programmer) to provide inputs. Lastly, the process traverses the tree and generates the UI instructions based on inputs entered by the user. For UI components which require data from the backend, “mock-up” data are inserted into the resulting UI instructions.

Another aspect of this invention, in an embodiment, provides screen-to-source association by inserting extra logic and data into the generated UI instructions and starting a listening process that listens to requests from the client. The extra UI logic and data encode the location of the source of the UI components corresponding to the screen elements and instruct the client to communicate to the listening process when the user double-clicks on the screen. In one embodiment the listening process will display and highlight the corresponding portion of source in a text editor upon receiving a request.

Another aspect of the present invention, in an embodiment, is a process which allows the programmers to specify one or more directories in which resource files referenced by the UI scripts will be searched. These resource files are files which can be other UI scripts, style sheets or images referenced by the UI script to be previewed and will form part of the screen created by the UI script. Once a resource is located in a directory, its reference will be rewritten in the UI instructions to point to that physical file.

Yet another aspect of the present invention, in an embodiment, is an Application Programming Interface (API). This API allows a user to create software “plug-ins” or “add-ons” for this invention to preview new UI components.

### OBJECTS AND ADVANTAGES

An advantage of the present invention is UI scripts are previewed in clients which display the screens exactly as expected in a real execution of the application. It does not require any special clients or any modification to the existing clients.

Another advantage of the present invention is it allows previewing the UI scripts without actually executing the scripts in a server. This eliminates the dependency of backend logic and data and facilitates the development process by decoupling of the development of the front-end UI and the development of the back-end business logic.

Still another advantage of the present invention is it shortens the development cycle of the UI scripts. Since it does not involve executing the scripts in a server and hence the time-consuming deploy-compile-restart cycle of the server, it shortens the time for a programmer to test and view the effect of incremental modifications done to the scripts. It also provides screen-to-source association such that a double-click on a location on the screen of the client will result in showing the corresponding portion of script in a text editor. This helps the programmer to locate the underlying source quickly when they need to modify portions of the screens.

Another advantage of the present invention is it allows proper previewing of the screens even if the UI scripts contain conditional logic which will affect the layout of the screens. The present invention provides a mechanism for the programmer to provide configuration to specify the values of this conditional UI components when previewing a script.

Yet another advantage of the present invention is it searches one or more directories for referenced resources and, thus, it allows these resources to be stored in a development-time directory structure which may be different from the deployment-time directory structure without copying and packaging the resources.

Another advantage of the present invention is it provides an API to allow a programmer to provide addition rules to preview new UI components. This is important because even at a given time all the existing UI components are covered by the present invention, new UI components will be developed and created after that. Providing an API allows the programmer to extend the predetermined set of translation rules of the present invention.

### BRIEF DESCRIPTION OF THE DRAWINGS

FIG. 1 is a block diagram of a computer system in which the present invention may be embodied.

FIG. 2A is a block diagram of a software system including the preferred embodiment of the present invention for controlling the operation of system of FIG. 1.

FIG. 2B is a block diagram showing the software components included in the preferred embodiment of the present inventions.

FIG. 3 is a bitmap screen shot illustrating an example of the GUI screen of configuration dialog 326 of FIG. 2B.

FIG. 4A is a flow chart illustrating the overall flow of the process of the present invention.

FIG. 4B is a flow chart illustrating a process of getting a syntax tree for a JSP.

FIG. 4C is a flow chart illustrating a process of collecting configuration items for a JSP.

FIG. 4D is a flow chart illustrating a process of generating HTML file for a JSP.

FIG. 5 is a bitmap screen shot illustrating a GUI screen for collecting “taglib mapping” in an operational example.

FIG. 6 is a bitmap screen shot illustrating a GUI screen for collecting settings of “doc roots” in an operational example.

FIG. 7 is a bitmap screen shot illustrating a GUI screen of configuration dialog 326 in an operational example.

FIG. 8 is a bitmap screen shot illustrating a resulting preview screen in Internet Explorer 406 in an operational example.

FIG. 9 is a bitmap screen shot illustrating a JSP code segment being highlighted in a text editor of JBuilder IDE 403 in an operational example.

### DETAILED DESCRIPTION OF THE PREFERRED EMBODIMENT

The following description will focus on a preferred embodiment of the present invention embodied as a computer program written in Java programming language hosted as a plug-in component inside Borland® JBuilder™ 5 IDE running on an Intel 80×86-compatible computer operating under an event-driven operating system, such as the Microsoft® Windows® environment. This preferred embodiment implements the process for previewing JSP files (the UI scripts) and providing screen-to-source association for the JSP files. The GUI screens will eventually be rendered in HTML (the UI instructions) transported on HTTP (the client-server protocol) and displayed in Microsoft® Internet Explorer 5 browser (the client). The present invention, however, is not limited to any particular environment. Instead, those skilled in the art will find that the system and methods of the present invention may be advantageously applied to a variety of software and hardware platforms and environments. Therefore, the description of the exemplary embodiment which follows is for purposes of illustration and not limitation.

General Architecture

A. System Hardware

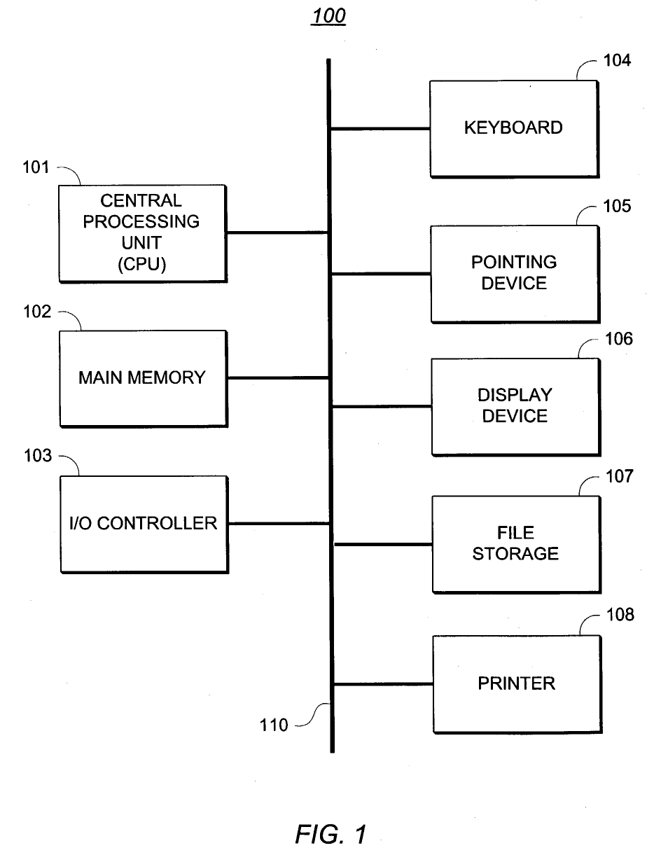

The present invention may be embodied on a computer system such as system 100 of FIG. 1, which includes a central processing unit 101, a main memory 102, an input/output controller 103, a keyboard 104, a pointing device 105 (e.g. mouse, track ball, pen device, or the like), a display device 106, and a file storage 107 (e.g. removable disk, floppy disk, fixed disk, optical disk (including CD-ROM), and the like). Additional input/output devices, such as a printing device 108, may be provided with the system 100 as desired. As shown, the various components of the system 100 communicate through a system bus 110 or similar architecture. In a preferred embodiment, system 100 includes an IBM-compatible personal computer.

B. System Software

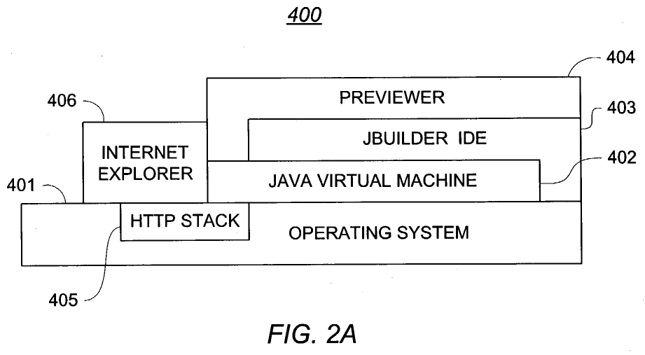

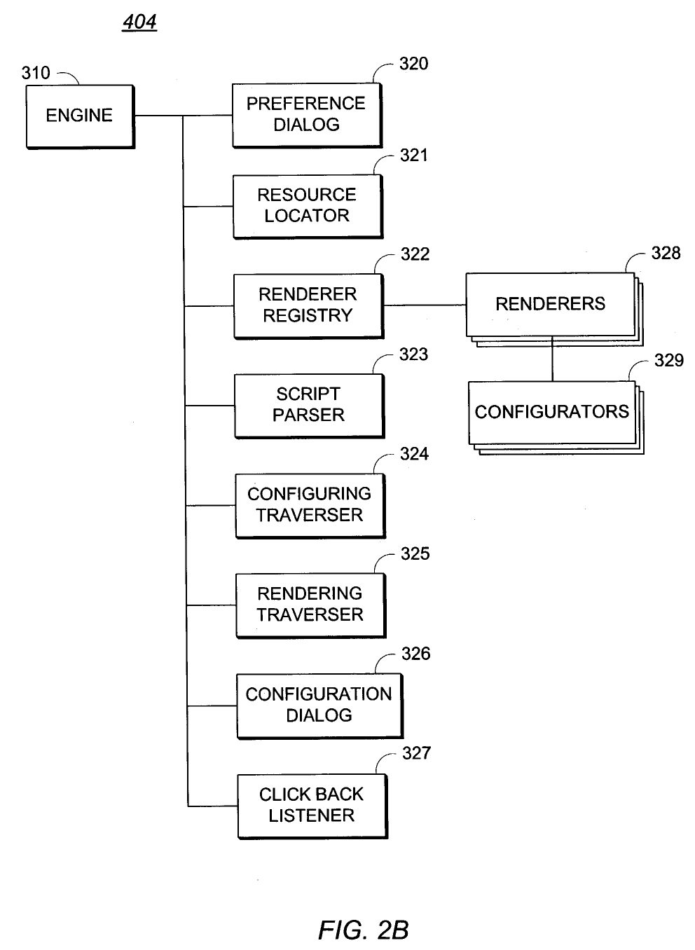

Illustrated in FIG. 2A, in a preferred embodiment, a computer software system 400 operates computer hardware system 100. Software system 400 includes a previewer 404 of the present invention for previewing JSP files. Software system 400, which is stored in system memory 102 and/or on disk storage 107, includes a kernel or operating system (OS) 401. Internet Explorer 406, JBuilder IDE 403 and previewer 404 include interfaces for receiving user commands and data and displaying results and other useful information. As shown, previewer 404 includes components which interface with the system 100 through a Java Virtual Machine (JVM) 402 and through JBuilder IDE 403, which in turns interfaces with JVM 402 and OS 401. Components 402, 403, 404 and 406 may be “loaded” (i.e., transferred from storage 107 into memory 102) for execution by the system 100. OS 401 includes also a HTTP networking protocol stack 405 which will be utilized by both previewer 404, via JVM 402, and Internet Explorer 406 for communication.

FIG. 2B shows software components included in previewer 404 of the present invention. All the components shown as blocks in the diagram are implemented as Java classes. Engine 310 is the “facade” of previewer 404 interfacing with JBuilder IDE 403. Engine 310 also acts as a “mediator” of previewer 404 coordinating the other functional components. When a user requests to preview a JSP, engine 310 will receive the request and coordinate various components to generate a preview screen and then interface with JVM 402 to open Internet Explorer 406 to display the preview screen. Engine 310 is also responsible to interface with JBuilder IDE 403 to display and highlight a source fragment of the JSP in a text editor when the user selects a location on the preview screen displayed in Internet Explorer 406.

In JSP technology, custom tags (i.e. UI components) are grouped and packaged as tag libraries, or “taglibs”. Each taglib has a corresponding tag library descriptor (TLD) file describing the API of its custom tags. In a web application, each taglib is given a unique identifier called “taglib URI”. These taglib URIs are used in the JSP files to refer to the TLDs. Since the same taglib can have different taglib URIs in different web applications, previewer 404 uniquely identifies a taglib not by taglib URI, but by the TLD filename. Preference dialog 320 defines a GUI dialog which allows a user to provide preference settings. These settings include a list of directories known as “document roots” (doc roots) in which resources will be searched and a map (called “taglib mapping”) which maps taglib URIs to their corresponding TLD file names. A resource locator 321 uses the doc roots specified by the user in preference dialog 320 to locate resources referenced by a JSP. These resources can be other JSP files, HTML files, style sheets or images. Resource locator 321 locates the resources by searching the directory of the document roots. An advantage of this is it allows resources to be stored in a development-time directory structure different from the deployment-time directory structure without copying and packaging the resources.

As shown in FIG. 2B, there is a plurality of renderers 328. Rules for rendering a custom tag into an HTML fragment are encapsulated inside one renderer. For each TLD, there is a corresponding preview library descriptor (PLD) file which maps the name of each custom tag in the taglib to a renderer. A PLD file relates to a TLD file through its file name. For example, struts-html.pld PLD file corresponds to struts-html.tid TLD file. Renderer registry 322 contains all the renderers 328 and uses the PLD files to find the renderer instance corresponding to a given custom tag. All the PLD files are placed in a fixed logical location (relatively to the Java classpath) known to renderer registry 322. Given a custom tag found in a JSP, renderer registry 322 uses the taglib mapping specified by the user in preference dialog 320 and the PLD files to determine which renderer to use. There is also a plurality of configurators 329. Each renderer associates with one configurator. While a render is responsible for translating a custom tag into an HTML fragment, a configurator is responsible to describe whether its associated renderer requires user inputs for configuration. These requirements of user inputs are called “configuration items”. A renderer may not require configuration. In such case, the configurator will return zero configuration items.

This architecture made up of renderer registry 322, renderers 328, configurators 329 and the PLD files has two benefits. First, it provides an API allowing a user to easily extend previewer 404 to preview new taglibs by registering to the renderer registry 322 a new PLD file with a corresponding set of new renderers and configurators. In other words, it provides a means for a user to extend the set of rules for rendering new taglibs. Second, using configurators 329 allows previewer 404 to prompt a user for inputs in order to preview custom tags containing conditional logic. For example, for a custom tag like <logic: equals> from the Struts framework mentioned before, previewer 404 can ask a user if he wants the tag to be evaluated as true or false.

Also shown in FIG. 2B is a script parser 323 which parses a JSP into an in-memory syntax tree. Each node in the syntax trees corresponds to either a custom tag, a HTML tag or a block of statements in the JSP. In other words, a node in the syntax tree corresponds to one or more blocks of statements in the JSP. Apart from storing the attributes and retaining the nesting structure of the tags of the JSP, each node is annotated with the start position and the end position of its corresponding block of statements and is assigned a unique identifier (node ID). In one embodiment, the annotation is achieved by directly storing the positions in a node and a node ID is made of a “stringified” object reference of its containing syntax tree object and a depth-first count of the node. However, this is not the only way. For example, in another embodiment, a node ID is assigned from an integer sequence and the annotation can be achieved by maintaining a lookup table mapping a node ID to a Pair object containing the positions. The essence is that given a node ID, the corresponding block of statements can be located within the JSP.

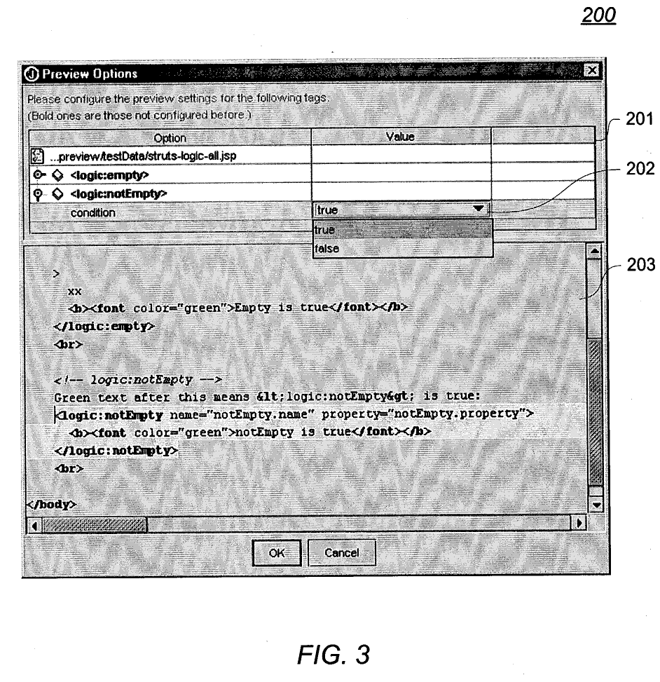

A configuring traverser 324 traverses nodes in the syntax tree of a JSP to collect the configuration items required by the custom tags in the JSP. A configuration dialog 326 defines a GUI dialog which displays the configuration items collected by configuring traverser 324 and gets the inputs from the user. FIG. 3 shows a GUI dialog 200, an example of the GUI of configuration dialog 326. As shown in the figure, a JSP “struts-all-logic.jsp” contains two custom tags requiring configuration, namely <logic: empty> and <logic: notEmpty>. Their configuration items are displayed in a table 201. <logic: notEmpty> has one configuration item called “condition” and a user can specify in a drop-down box 202 to set this item to “true” or “false”. (Similarly to <logic:equals>, “true” means the nested body will be displayed while “false” means the nested body will be turned off.) To assist the user to distinguish instances of custom tag with the same tag name in a JSP, GUI dialog 200 also shows and highlights the corresponding source code section in a bottom text panel 203 when the user selects a configuration item.

A rendering traverser 325 traverses nodes in the syntax tree of a JSP to generate and save a HTML file. Click-back listener 327 is an HTTP listener listening to the port mentioned above. Upon receiving an HTTP request, it will use the node ID from the request to locate the JSP syntax tree and the node. Then, it will locate the JSP file, retrieve the start and end positions stored in the node and send a request via engine 310 to JBuilder IDE 403 to display and highlight the corresponding section of source.

Process Flow

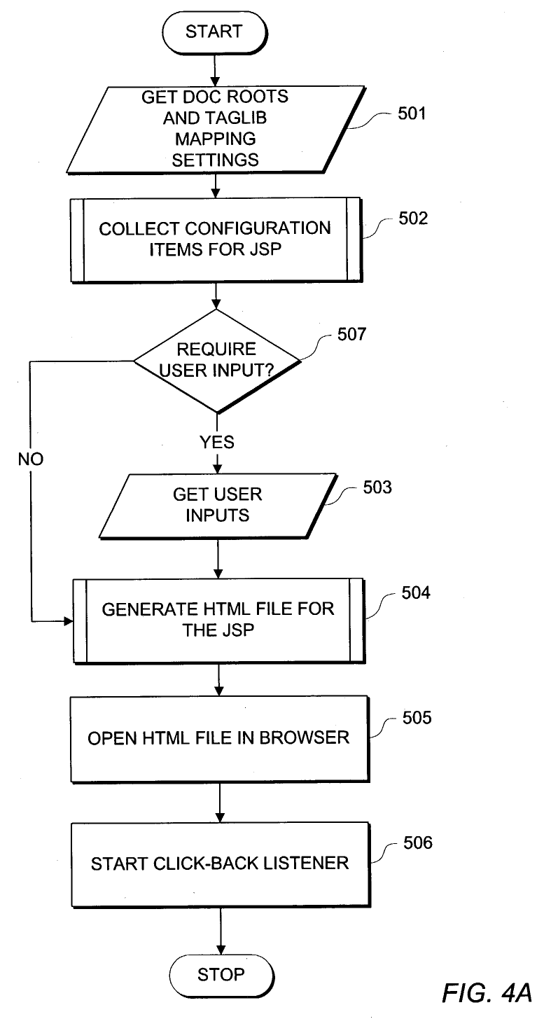

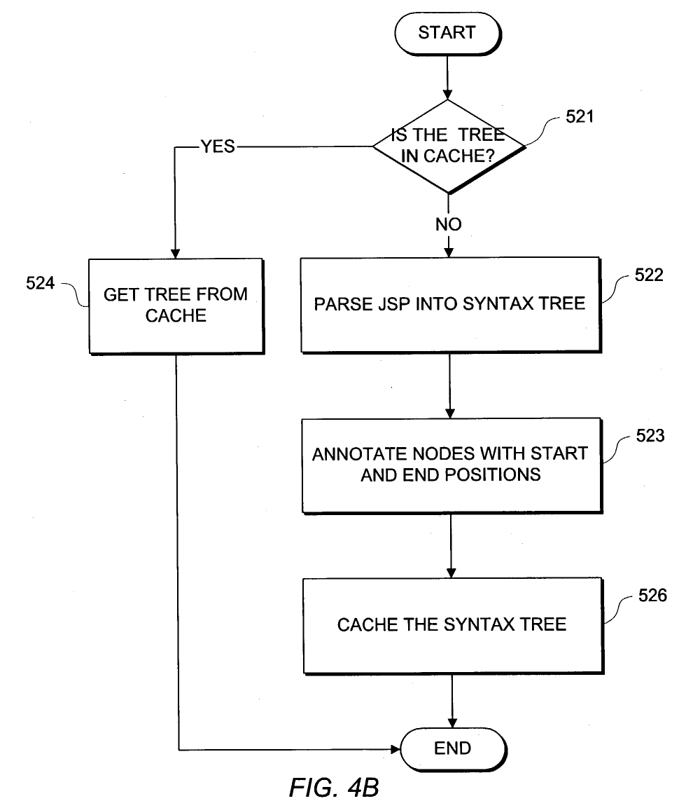

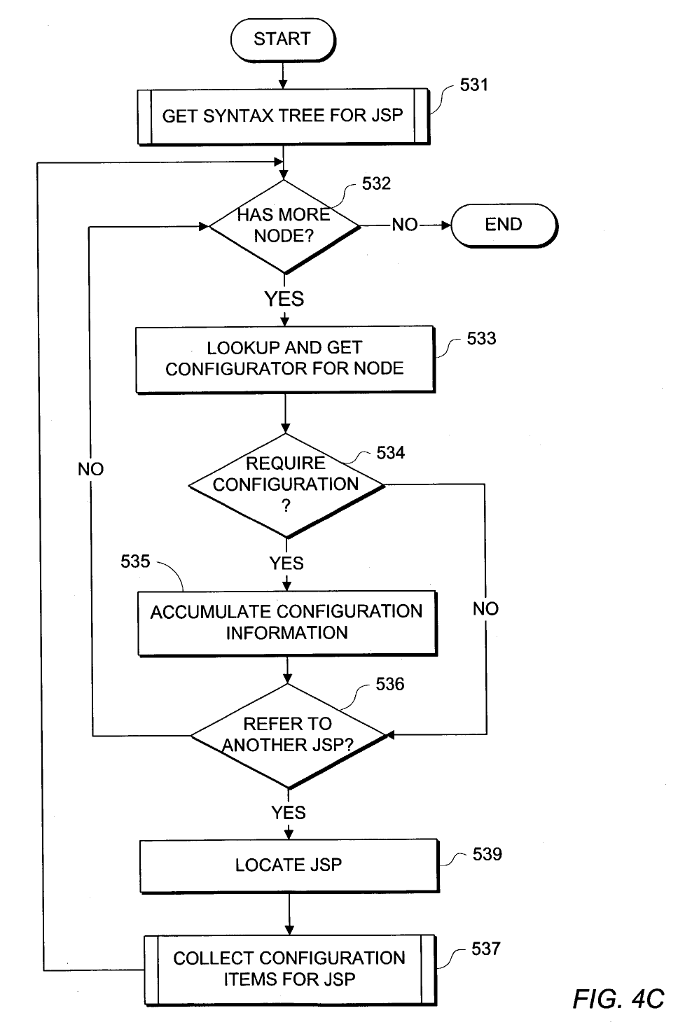

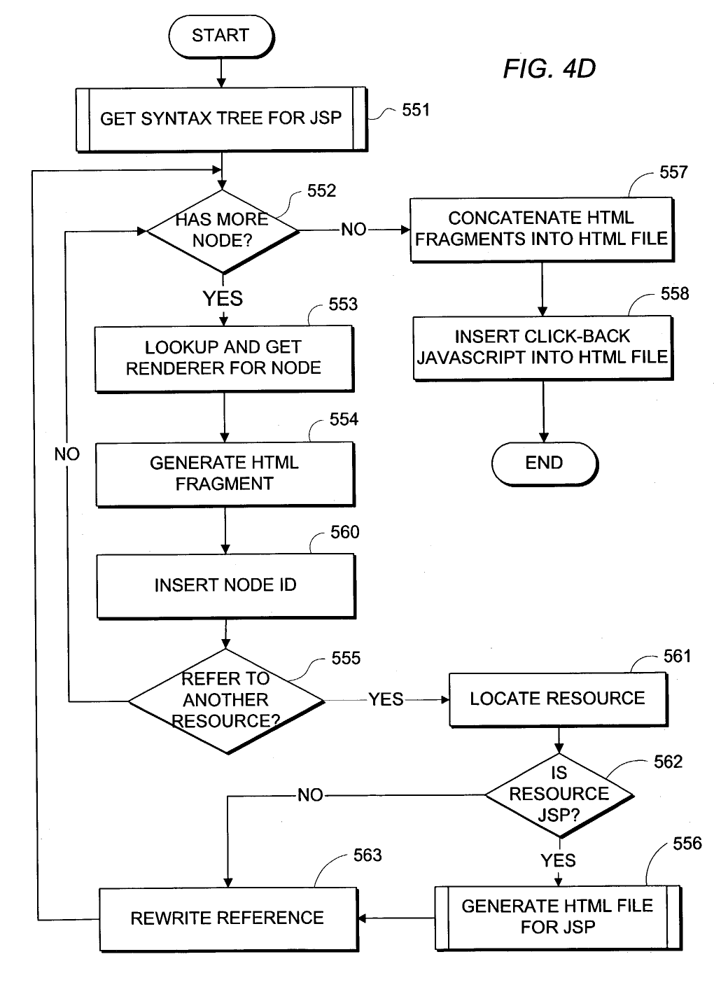

FIG. 4 is a flow chart summarizing the overall execution sequence of the present invention. The execution sequence is coordinated and initiated by engine 310 upon receiving a request from a user to preview a JSP. At step 501, a user provides the settings of the doc roots and the taglib mapping through preference dialog 320. The setting of doc roots will be used by resource locator 321 to locate resources while the setting of taglib mapping is used by the renderer registry 322 to map a custom tag to a corresponding renderer 328 and a corresponding configurator 329. At step 502, a sub-process “collect configuration item for JSP” is executed to collect all the configuration items for the JSP. The test at step 507 determines if the JSP requires any user inputs by checking if there are any configuration items collected in step 502. If yes, at step 503, configuration dialog 326 is displayed and gets the user's inputs for the configuration items. Step 502, step 503 and step 507 together provide a mechanism for a user to provide configuration for determining the values of conditional UI components when previewing a JSP. The advantage of this is it allows proper previewing of the screen even if the JSP contains conditional logic which will affect the layout of the screen.

At step 504, a sub-process “generate HTML file for JSP” is executed to generate a HTML file for the JSP. At step 505, the process save the HTML file and opens Internet Explorer 406 to display the HTML file. At step 506, the process starts a click-back listener 327. If the user double-clicks on a location of the displayed HTML in Internet Explorer 406, an HTTP request will be sent to click-back listener 327. Click-back listener 327 will responds by displaying the JSP and highlight the corresponding section of the JSP code in a text editor of JBuilder IDE 403. Thus, the JSP is previewed in Internet Explorer 406, an unmodified client, which renders the screen exactly as expected in a real execution of the application without actually executing the JSP in a server. Besides, click-back listener 327 provides screen-to-source association such that a double-click on a location on the screen of Internet Explorer 406 will result in showing the corresponding portion of the JSP.

FIG. 4C shows the execution sequence of the sub-process “collect configuration items for JSP” which will be called at step 502. This execution sequence is coordinated by configuring traverser 324. At step 531, a sub-process “get syntax tree for JSP” is executed to get a syntax tree for the JSP. If the test at step 532 determines there is no more nodes in the syntax tree, the sub-process finishes and returns the collected configuration items. Otherwise, at step 533, configuring traverser 324 queries renderer registry 322 to locate a configurator 329 corresponding to the tag represented by the node. At step 534, configurator 329 is queried to test if the node requires configuration. If the test returns true, at step 535, a required set of configuration items is collected and accumulated. Then, if the test at step 536 determines the tag refers to a server-side inclusion or frame of another JSP, at step 539, resource locator 321 will locate the referenced JSP based on the settings of doc roots collected at step 501. Configuring traverser 324 will then call itself recursively at step 537 to collect the configuration items from the included JSP.

FIG. 4D shows the execution sequence of the sub-process “generate HTML file for JSP” which will be called at step 504. This execution sequence is coordinated by rendering traverser 325. At step 551, the sub-process “get syntax tree for JSP” is executed to get a syntax tree for the JSP. If the test at step 552 determines there is more node in the syntax tree, at step 553, rendering traverser 325 will query renderer registry 322 to find a corresponding renderer for a node. At step 554, the renderer applies its rules to generate a HTML fragment. The Rules include applying to the node the configuration items, collected at step 502, corresponding to the custom tag represented by the node and inserting mock-up data. At step 560, the renderer will insert an extra attribute containing the node ID into the generated HTML tag. If a node does not directly map to an HTML tag, a <span> will be inserted in order to add the node ID attribute. At step 555, the test determines if the tag refers to a server-side inclusion or frame of another resource. If yes, resource locator 321 will locate the referenced resource based on the settings of doc roots collected at step 561. Test at step 562 determines if the resource is a JSP. If yes, rendering traverser 325 will call itself recursively at step 556 to generate the HTML fragments of the included JSP. At step 563, external resource reference (e.g. image, style sheet) will be rewritten to point to the located physical file while inline resource reference (i.e. server-side JSP inclusion) will be written with the HTML fragment generated at step 556. After traversing through all the nodes, at step 557, rendering traverser 325 will concatenate all the HTML fragments into a HTML file. And then at step 558, it inserts into the HTML a section of “click-back” Javascript which will respond to double-clicks on the browser and send HTTP requests containing the node ID value associated with the HTML tag corresponding to the selected screen location. These HTTP requests are sent to a predefined port on the local host. The HTML file is returned back to the caller.

FIG. 4B shows the execution sequence of the sub-process “get syntax tree for JSP”, which will be called at step 531 and step 551. This execution sequence is coordinated by script parser 323. The sub-process first at step 521 tests if a syntax tree corresponding to the JSP exists in a cache. If yes, the syntax tree is retrieved from the cache at step 524 and returned. If no, the JSP is parsed into a new syntax tree at step 522. At step 523, all the nodes in the syntax tree are annotated with the start and end positions of their corresponding blocks of statements in the JSP. At step 526, the syntax tree is cached and returned back to the caller.

AN OPERATIONAL EXAMPLE

The present invention is commercially embodied as Scioworks Collage, a plug-in component for various integrated Java development environments, including Borland® JBuilder™ 5 IDE. The following example illustrates an operation of this embodiment.

The following list is an example of JSP, This JSP is stored in file C:\tmp\example.jsp. It uses custom tags <html:form>, <html:image>, <html:text>, <bean:message> and <logic:equal> from the Struts framework. Of all the custom tags, only <logic:equal> tags requires configuration from user's inputs. This JSP references to an image “collagel6.gif” stored in the file C:\tmp2\collage16.gif, which is of a different directory to the JSP.

<%@ taglib uri=“/WEB-INF/struts-logic.tld”
prefix=“logic” %>
<%@ taglib uri=“/WEB-INF/struts-html.tld” prefix=“html” %>
<%@ taglib uri=“/WEB-INF/struts-bean.tld” prefix=“bean” %>
<html>

<title>Example</title>
<body>

<h1>Example</h1>
<html:form action=“/anAction”>

This is a text field:
<html:text property=“field1”/><p>
This is a message: <bean:message key=“key1”/><p>
This is an image:
<html:image page=“/collage16.gif”/><p>
<logic:equal name=“displaySwitch” value=“case1”>

This text displays if displaySwitch = “case1”<p>

</logic:equal>
<logic:equal name=“displaySwitch” value=“case2”>

This text displays if displaySwitch = “case2”<p>

</logic:equal>

</html:form>

</body>

</html>

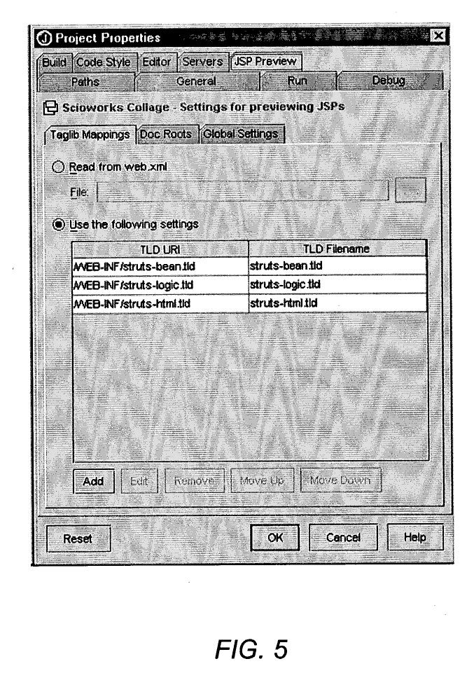

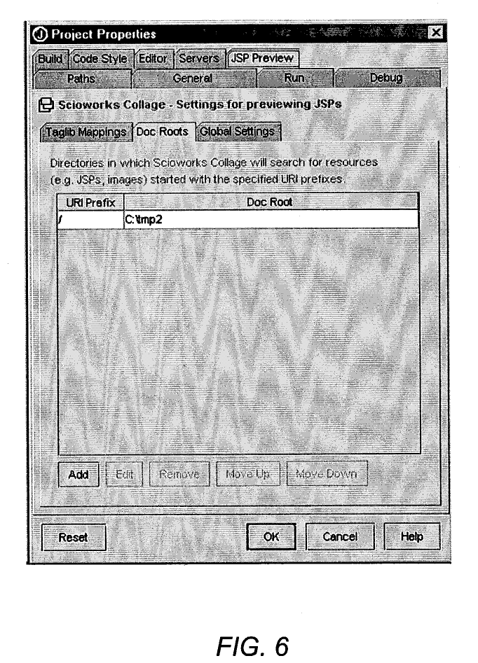

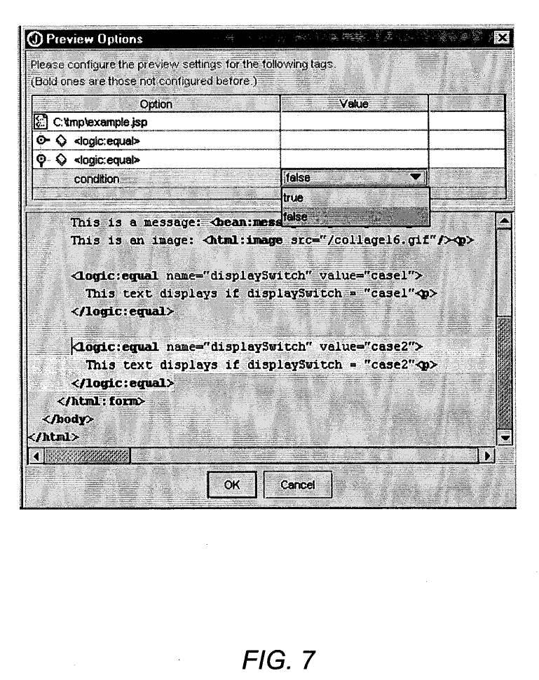

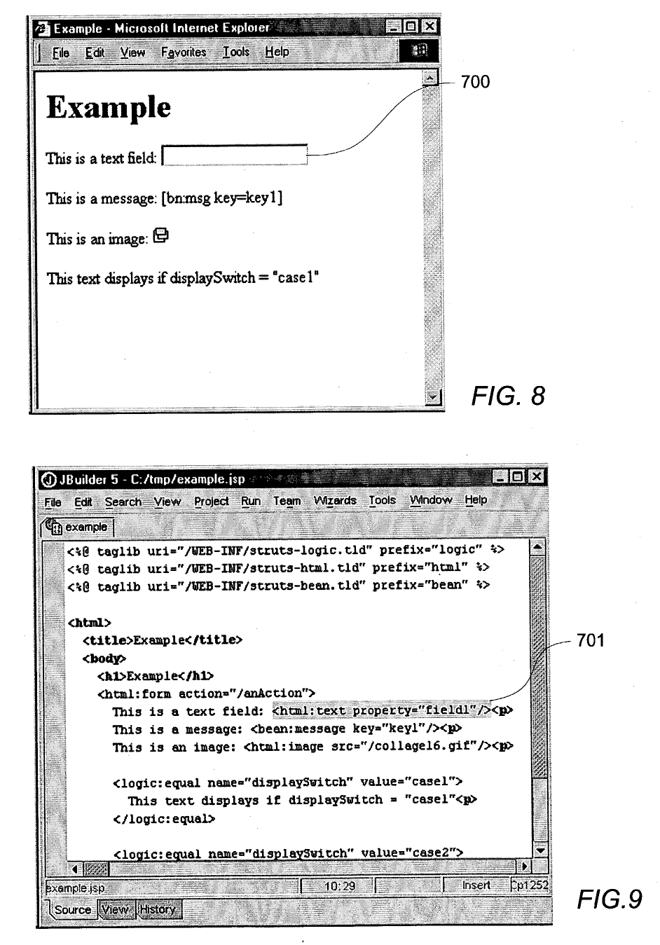

When the process of the present invention is executed, GUI screens shown in FIG. 5 and FIG. 6 will be displayed as at step 501. FIG. 5 shows a GUI screen of preference dialog 320 for getting a taglib mapping from a user. (As shown in the figure, logical taglib URI “/WEB-INF/struts-html.tid” maps to TLD file name “strut-shtml.tid”, etc.) FIG. 6 shows another GUI screen of preference dialog 320. This GUI screen gets settings of doc roots from the user. (As shown in the figure, directory “C:\tmp2” is set as a doc root. This is the directory where image “collage16.gif” can be found.) As at step 503 of the process, GUI screen shown in FIG. 7 will be displayed for getting user's inputs for configuration items of the two instances of <logic:equal>. In this example, the first <logic:equal> is set to “true” and the second is set to “false”. Then, as at step 505, FIG. 8 shows the resulting preview screen displayed in Internet Explorer 406. The following list shows the resulting HTML source:

<html scio=“scioworks.jsp.parser.JspDocument@7951b0;6”>
<head>
<script language=“Javascript”>

function previewEventIE(e) {

var we = window.event.srcElement;
var eid = null;
while (eid == null && we != null) {

eid=we.getAttribute(‘scio’); we=we.parentElement;

}
var dt = new Date().getTime();

window.open (“http://127.0.0.1:6619/preview?previewId=”+e
id+“&dt=”

+dt, “previewEventIE”,
“location=no,menubar=no,scrollbars=no,status=no,
toolbar=no,top=0,left=0,width=1,height=1”);

return false;

}

</script></head>
<title scio=“scioworks.jsp.parser.JspDocument@7951b0;8”>
Example
</title>

<body ondblclick=“javascript:previewEventIE()”

scio=“scioworks.jsp.parser.JspDocument@7951b0;12”>

```
<h1 scio=“scioworks.jsp.parser.JspDocument@7951b0;14”>
Example</h1>
<form
  scio=“scioworks.jsp.parser.JspDocument@7951b0;18”
  action=“/anAction”>
```

```
This is a text field:
<input name=“field1” type=“text”
  scio=“scioworks.jsp.parser.JspDocument@7951b0;20”>
<p scio=“scioworks.jsp.parser.JspDocument@7951b0;21”>
This is an image:
<input type=“image”
  scio=“scioworks.jsp.parser.JspDocument@7951b0;23”
  src=“file:/C:/tmp2/collage16.gif”>
<p
  scio=“scioworks.jsp.parser.JspDocument@7951b0;24”>
<span
    scio=“scioworks.jsp.parser.JspDocument@7951b0;26”>
    This text displays if displaySwitch = “case1”
    <p
  scio=“scioworks.jsp.parser.JspDocument@7951b0;28”>
</span>
```

</form>

</body>

</html>

Attribute values like “scioworks.jsp.parser.JspDocument@7951b0;12” are node IDs inserted to the tags for locating the start position and the end position of the block of statements corresponding to the node. A Javascript function “previewEventIE” is inserted at the top which will send a request with a node ID to click-back listener 327 when the user double-clicks on a screen location. For example, if text field 700 is double-clicked, node ID “scioworks.jsp.parser.JspDocument@7951b0;20” will be sent to click-back listener 327. Click-back listener 327 will locate the corresponding source fragment and display and highlight it in a text editor of JBuilder IDE 403 as shown as a highlight block 701 in FIG. 9.

Thus, a method and apparatus for previewing UI scripts and providing screen-to-source association is disclosed. The specific arrangement and methods described herein are merely illustrative of the principles of the present invention. Numerous modifications in form and details may be made by those of ordinary skill in the art without departing from the scope of the present invention. Although this invention has been shown in relation to a particular preferred embodiment, it should not be considered so limited. Rather, the present invention is limited only by the scope of the appended claims.

What is claimed is:

1. A computer-implemented method for previewing in a client a resulting screen of a script defining a user interface screen of a client-server program and providing screen-to-source association, wherein said script consists of one or more logical blocks of statements and said client includes a graphical user interface, comprising the steps of:
a) parsing said script to generate a syntax tree comprising a plurality of nodes, such that each of said logical blocks of statements has a corresponding node in said syntax tree,
b) annotating each of said plurality of nodes with start position and end position of its corresponding logical block of statements within said script,
c) generating based on a predetermined set of rules from each of said plurality of nodes a fragment of computer instructions that can be executed by said client, wherein said fragment of computer instructions defines a portion of graphical user interface screen and encodes an identifier which provides means for locating a corresponding logical block of statements within said script,
d) concatenating fragments of computer instructions generated from said plurality of nodes into a list of computer instructions which defines a graphical user interface screen,
e) inserting into said list of computer instructions an extra fragment of computer instructions which will instruct said client to send a request to a predetermined network address and port when a user selects a screen position with a pointing device on said graphical user interface of said client, wherein said request contains an identifier from a fragment of computer instructions corresponding to said screen position,
f) executing said list of computer instructions in said client,
g) listening to said predetermined network address and port,
h) displaying in a second graphical user interface a logical block of statements of said script indicated by its corresponding identifier contained in a request received from said client,
whereby a user can visualize said script in said client without executing said script in a server, and
whereby said user can associate a position on the screen of said client to a corresponding logical block of statements of said script.

2. The computer-implemented method of claim 1 wherein
a) said client is a browser,
b) said fragment of computer instructions includes HTML tags,
c) said list of computer instructions is an HTML file, and
d) said request is an HTTP request,
i) executing said list of computer instructions in said client includes saving said HTML file into a file storage system and opening said HTML file in said browser, and
j) listening to said predetermined network address and port includes starting a HTTP listener.

3. The computer-implemented method of claim 2 wherein said extra fragment of computer instructions includes a plurality of Javascript statements,

4. The computer-implemented method of claim 2 wherein said script is a JSP file.

5. The computer-implemented method of claim 4 further comprising providing a user interface for a user to specify a plurality of directories and wherein generating includes searching said directories for resources referenced by said JSP file and repeating the step of parsing to the step of generating recursively for a referenced JSP file if a resource is another JSP file.

6. The computer-implemented method of claim 1 wherein generating based on a predetermined set of rules from each of said nodes a fragment of computer instructions that can be executed by said client depends on zero or more inputs from a user.

7. The computer-implemented method of claim 1 further comprising providing means for a user to extend the set of rules.

8. The computer-implemented method of claim 1 wherein said identifier includes a stringified object reference of said syntax tree and a depth-first count of the corresponding node.

9. A computer system for previewing in a client a resulting screen of a script defining a user interface screen of a client-server program and providing screen-to-source association, wherein said script consists of one or more logical blocks of statements and said client includes a graphical user interface, comprising:
a) a parser which parses said script to generate a syntax tree comprising a plurality of nodes, such that each of said logical blocks of statements has a corresponding node in said syntax tree, and annotates each of said plurality of nodes with start position and end position of its corresponding logical block of statements within said script,
b) a generator which
i. generates based on a predetermined set of rules from each of said plurality of nodes a fragment of computer instructions which can be executed by said client, wherein said fragment of computer instructions defines a portion of graphical user interface screen and encodes an identifier which provides means for locating a corresponding logical block of statements within said script,
ii. concatenates fragments of computer instructions generated from said plurality of nodes into a list of computer instructions which defines a graphical user interface screen, and
iii. inserts into said list of computer instructions an extra fragment of computer instructions which will instruct said client to send a request to a predetermined network address and port when a user selects a screen position with a pointing device on said graphical user interface of said client, wherein said request contains an identifier from a fragment of computer instructions corresponding to said screen position,
c) a listener which listens to said predetermined network address and port and displays in a second graphical user interface a logical block of statements of said script indicated by its corresponding identifier contained in a request received from said client,
whereby a user can visualize said script in said client without executing said script in a server, and
whereby said user can associate a position on the screen of said client to a corresponding logical block of statements of said script.

10. The computer system of claim 9 wherein
a) said client is a browser,
b) said fragment of computer instructions includes HTML tags,
c) said list of computer instructions is an HTML file,
d) said request is an HTTP request, and
e) said listener is an HTTP listener,

11. The computer-implemented method of claim 10 wherein said extra fragment of computer instructions includes a plurality of Javascript statements,

12. The computer system of claim 10 wherein said script is a JSP file.

13. The computer system of claim 12 further comprising a user interface for a user to specify a plurality of directories and wherein said generator searches said directories for resources referenced by said JSP file and recursively generates computer instructions for a referenced JSP file if a resource is another JSP file.

14. The computer system of claim 9 wherein said generator depends on zero or more inputs from a user.

15. The computer system of claim 9 further comprising an application program interface for a user to extend the set of rules.

16. The computer system of claim 9 wherein said identifier includes a stringified object reference of said syntax tree and a depth-first count of the corresponding node.
